(19) United States
(12) Patent Application Publication
(10) Pub. No.: US 2007/0107532 A1
(43) Pub. Date: May 17, 2007

(54) Sensor holder

(75) Inventors: Lars Ake Naslund, Furulund (SE); Tommy Nilsson, Svedala (SE)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance S.A., Pully (SE)

(21) Appl. No.: 10/561,228

(22) PCT Filed: Jun. 8, 2004
(86) PCT No.: PCT/SE04/00892

§ 371 Date: Dec. 19, 2005

(30) Foreign Application Priority Data
Jun. 19, 2003 (SE) 0301780-3

(51) Int. Cl. G01N 3/02

(52) U.S. Cl. 73/856

(57) ABSTRACT

TThe present invention refers to a sensor holder (10) for arranging a sensor (32) through the wall and into communication with the inside of a housing (44). It comprises a first and a second component (12,14), the first component (12) being adapted to hold said sensor (32), the second component (14) being provided with a first sealing surface (36) and at least one throughgoing opening (38). A portion of the sensor (32) being adapted to extend from the first component (12), through the opening (38) in the second component (14) and into communication with the inside of the housing (44).

### THE FIELD OF INVENTION

The present invention refers to a sensor holder for arranging at least one sensor through the wall and into communication with the inside of a housing.

### TECHNICAL BACKGROUND

It is common to use various kinds of sensors for sensing or measuring different parameters in processes, for example the amount of a certain substance, the temperature, the pressure, the flow etc. Sometimes it is needed to carry out such a sensing operation inside a closed housing. One way of performing such is to provide a throughgoing opening in the housing wall in which the sensor can be received and brought to communication with the inside of the housing. One of the issues to consider when arranging a sensor in an opening in a housing wall is the sealing between the environment inside the housing and the environment surrounding the housing. In some fields it is a necessity to provide a tight sealing between the sensor and the housing wall. However, it is sometimes not that simple to provide a throughgoing opening in the housing wall corresponding to the cross section of the sensor. For instance, if the sensor has a rectangular or squared cross section and the housing wall has a considerable thickness, it can be very difficult to achieve a corresponding throughgoing opening due to for example limitations in machining and cost-effectiveness. A failure in manufacturing a correct throughgoing opening may lead to that the housing must be scrapped. For example, when dealing with housings with thick walls it is preferred to form an oval or circular opening, as such forms can be easily achieved with drilling or milling machines.

Further, in hot temperature processes the sensor is sometimes exposed to considerable heat. To avoid damage to the sensor due to the heat it is often desired to provide the sensor with means acting as cooling flanges, thereby transferring the heat away from the sensor. One way of providing heat transfer is to design the sensor holder as a cooling flange. However, this raises additional demands on the design of the sensor holder. For instance, the heat transfer is among other things dependent on the size of the contact surfaces between the sensor holder and the sensor. Large contact surfaces provide for a better heat transfer than smaller contact surfaces.

### SUMMARY OF THE INVENTION

Therefore, an object of the invention has been to provide a sensor holder for providing a sensor in communication with the inside of a housing, which sensor holder provides for a tight sealing between the housing and the sensor and where the cross section of the sensor may have a different form than the opening in the housing.

Further, an additional object of the invention has been to provide a sensor holder that provides for a sufficient heat transfer from the sensor.

These obejcts have been achieved by a sensor holder comprising a first and a second component, the first component being adapted to hold said sensor, the second component being provided with a first sealing surface and at least one throughgoing opening, a portion of the sensor being adapted to extend from the first component, through the opening in the second component and into communication with the inside of the housing, the envelope surface of the throughgoing opening in the second component being adapted to be tightly sealed to the sensor when pressing together the first and second component of the sensor holder, and the first sealing surface of the second component being adapted to be tightly sealed to a second sealing surface provided in the housing. when pressing together the sensor holder and the housing. Since the sensor is not sealed directly to the opening in the housing, the sensor can for instance have a rectangular form, whereby the opening in the housing can have a form made by drilling or milling machines such as an oval or circular form, the latter forms being easier to manufacture than the rectangular form if the housing wall has a considerable thickness.

In a preferred embodiment of the invention the throughgoing opening of the second component is conical or at least frusto conical, the conical or at least frusto conical form being widened towards a surface opposite the first sealing surface, and whereby first sealing means is provided in the conical or at least frusto conical part of the throughgoing opening. The conical or at least frusto conical form forces the sealing means into contact with both the sensor and the sensor holder which provides a tight and reliable sealing between the two. Thus, the environment delimited by the housing will not be able to escape to the outside of the sensor holder.

In another preferred embodiment the second sealing means is provided between the first sealing surface and the second sealing surface. In this way a further reliable and tight seal is obtained between the second component and the surface of the housing.

Preferably, the sealing means is a compressible sealing ring such as an O-ring. The use of conventional sealing means is above all cost effective, and shows consistent, well-defined sealing properties.

In a preferred embodiment the throughgoing opening in the second component of the sensor holder and the sensor have rectangular forms. It is easier to provide for sufficient heat transfer from a sensor having a rectangular form than from a circular sensor since it is possible to provide a larger contact surface between the surfaces of a rectangular sensor and its surrounding surfaces, by for instance clamping, than around a circular form, which is more difficult to clamp around. The larger area that is in contact with the “cooling flanges” the better heat transfer can be achieved.

Advantageously, the throughgoing opening in the housing has an oval or circular form. In housings with considerable wall thicknesses it is difficult to manufacture rectangular or square openings since the size of the drill or mill tools needed to be able to treat the material renders creation of right-angled corners impossible.

It is an advantage if the first sealing surface being provided with a groove for receiving the second sealing means, the groove having an oval or circular form. By this groove the sealing means can be easily fitted to the surface of the sensor holder, which will in turn facilitate assembling to the housing. Further, the risk of having the seal misplaced during use is minimised.

In a preferred embodiment the first portion is provided with a groove adapted to receive at least a portion of the sensor. This is a simple and efficient way of placing the sensor in the sensor holder, while at the same time provide for large contact surfaces between the sensor and the sensor holder.

Advantageously, the groove is rectangular and has a depth less than the length between two opposite sides of the sensor whereof one of said sides is facing the bottom of the groove. In this way it is secured that at least one surface of the sensor can be brought into contact with the bottom of the groove and the opposite surface of the sensor can be acessed by another part, thereby enabling necessary heat transfer.

Preferably, the first component further comprising a second portion and that the first and second portions being adapted to be clamped together by first fastening means. By clamping together the two portions of the first component the sensor is held in a stable and reliable way providing necessary heat transfer. This clamping of two portions also makes it possible to use simple fastening means, which in turn facilitates exchange of the sensor.

In a preferred embodiment it is provided second fastening means for tightening the first and second components to each other. The force acting on the first sealing means can thereby be optimised independently of the force with which the sensor holder is tightened to the housing.

In another preferred embodiment it is provided third fastening means for tightening the sensor holder to the housing.

Preferably, the fastening means is a screw joint. Screw joints are well known, have consistent and well-defined fastening properties and are cost effective.

### BRIEF DESCRIPTION OF THE DRAWINGS

In the following, a presently preferred embodiment of the invention will be described in greater detail, with reference to the enclosed drawings, in which:

FIG. 1 shows an exploded view in perspective of a sensor holder according to the invention and a portion of a housing to which the sensor holder is adapted to be fastened,

FIG. 2 shows an exploded view in perspective of an assembled sensor holder according to FIG. 1, ready to be fastened to the housing portion,

FIG. 3 shows a view in perspective from “inside the housing” showing how the sensors extend through the throughgoing opening and into the housing space, and

FIG. 4 shows a view in perspective of the sensor holder when the first and second components have been tightened to each other.

### DESCRIPTION OF A PREFERRED EMBODIMENT

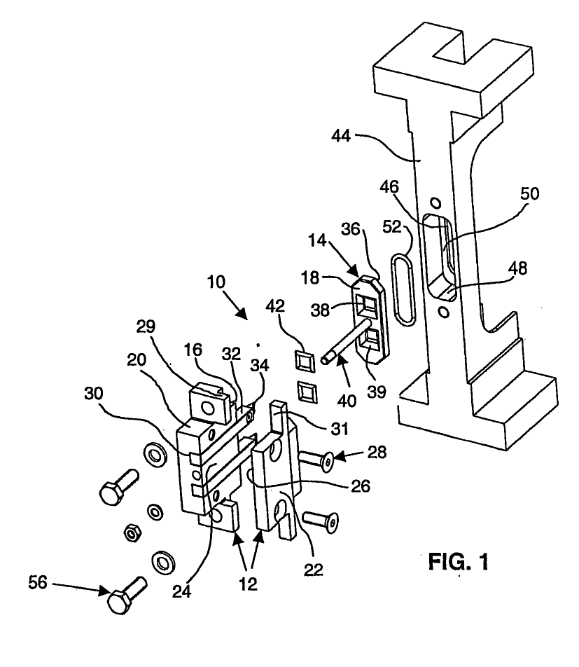

In FIG. 1 is shown a sensor holder, which has been denoted with the reference numeral 10. The holder comprises a first component 12 being a clamping device 12 and a second component 14 being a housing interface portion 14. The clamping device 12 and the housing interface portion 14 are adapted to be pressed against each other and are each provided with a respective surface 16, 18. The surfaces 16, 18 are adapted to face towards each other when the clamping device 12 and the housing interface portion 14 are pressed together.

The clamping device 12 has the form of a block, which is divided into a first and a second portion 20, 22 each having a clamping surface 24, 26 facing. the other. The division is made so that the surface 16 adapted to face towards the housing interface portion 14 is split into two parts.

In the described embodiment the first and second portions 20, 22 of the clamping device 12 are adapted to be clamped to each other by first fastening means 28. The fastening means 28 can for example be a screw joint. To prevent any motion to occur in a direction perpendicular to the clamping direction, i.e. that the two portions 20, 22 slide in relation to each other, the first portion 20 is provided with at least one shoulder 29 adapted to cooperate with a surface 31 in the second portion 22. A surface of the shoulder 29 and the surface 31 are located in a plane substantially perpendicular to the clamping surfaces 24, 26.

The first portion 20 of the clamping device 12 is provided with at least one groove 30 adapted for receiving at least one sensor 32. The groove 30 is made in the clamping surface 24 and have sides located substantially perpendicular to said surface 24, and a bottom surface substantially parallell to and offset from the clamping surface 24. The groove 30 extends from one side of the first portion 20 to an opposite surface 16, said surface 16 being the above described surface 16 adapted to face the housing interface portion 14. The relation between the groove 30 length and the longitudinal length of the sensor 32 is such that a sensing element 34 of the sensor 32 will extend a desired distance out of the groove 30, i.e. extend in a direction out from the surface 16 when the sensor 32 has been received in the groove 30. The distance that the sensor 32 shall extend from said surface 16 will be described in more detail later.

In the described embodiment there is provided two sensors 32, thus two grooves 16 are provided in the first portion 20 of the clamping device 12. The grooves 16 extend in a direction transverse to the direction in which the first and second portions 12, 14 are clamped. Thus, when clamping together the first and second portion 12, 14 of the clamping device 12, the sensors 32 are adapted to be squeezed between the bottom surface of the groove 30 and the clamping surface 26 of the second portion 22 of the clamping device 12.

Below only one sensor 32 will be described in more detail. The sensor 32 in this embodiment has the form of a bar with rectangular cross section. As mentioned above one of its ends is provided with a sensing element 34. For example the sensing element 34 can be of the type sensing the amount of electrons generated by an electron. beam emitter. In the other end there is provided a cable out-feed (not shown) connected to for example a control unit or a monitoring device.

The groove 30 in the first portion 20 of the clamping device 12 has a cross section substantially corresponding to that of the sensor 32. Thus, the groove 30 in this case has a rectangular cross section. However, the groove 30 is sligthly more shallow than the sensor 32. In-other words, the groove 30 has a depth less than the length between two opposite sides of the sensor 32 whereof one of said sides is facing the bottom of the groove 30. Preferably, the groove. 30 is also sligthly wider than the sensor 32, i.e. the width of the groove is larger than the length between the other two opposite sides of the sensor 32. This differences in cross section makes it possible to slide the sensor 32 into the groove 30 while leaving a small longitudinal portion of the sensor 32 outside the groove 30 in the clamping direction. Thus, when clamping together the first and second portion 20, 22 there will be a very close connection between on one hand a side surface of the sensor 32 and the bottom surface of the groove 30, and on the other hand an opposite side surface of the sensor 32 and the clamping surface 26 of the second portion 22 of the clamping device 12. Thereby, the first and second portion 20, 22 will act as cooling flanges for the sensor 32.

The second component 14, being the housing interface portion 14, comprises a plate with a first sealing surface 36 and a surface 18 adapted to face towards the clamping device 12. In addition to the surface 18 and the first sealing surface 36 the housing interface portion 14 is provided with at least one throughgoing opening 38 for each sensor 32, through which throughgoing opening 38 the sensor 32 is adapted to extend. The throughgoing opening 38 extends from the surface 18 adapted to face the clamping device 12 and the first sealing surface 36. The form of the throughgoing opening 38 substantially corresponds to the cross section of the sensor 32 and is therefore rectangular in this embodiment. A portion 39 of the throughgoing opening 38 of the housing interface portion is frusto conical, and the frusto conical form is widened towards a surface opposite the first sealing surface 36.

Between the envelope surfaces of the sensor 32 and the envelope surface of the throughgoing opening 38 in the housing interface portion 14, first sealing means 42 is provided. The sealing means 42 is located in the frusto conical portion 39 of the throughgoing opening 38 and for instance the sealing means 42 is a compressible sealing ring such as an O-ring 42. The size of the sealing means 42 is choosen such that when pressing together the clamping device 12 and the housing interface portion 14, the sealing means 42 will bear on at least the frusto conical surface, at at least one point and thus forming an abutment line extending around the opening 38, and the envelope surface of the sensor 32, at at least one point, and thus forming an abutment line extending around the sensor 32.

To be able to tighten the housing interface portion 14 to the clamping device 12 the housing interface portion 14 is provided with second fastening means 40, which in this embodiment is a screw joint 40. The screw joint 40 is made up by a screw provided in the housing interface portion 14 and a corresponding throughgoing opening in the clamping device 12. The screw can for instance be located between the two sensor throughgoing openings 38.

The sensor holder 10 is adapted to be tightened to a housing 44. The housing 44 is adapted to delimit a space comprising the environment to be measured by the sensor 32. The inside of the space and the thickness of the housing wall are designed depending on the field of application. In FIG. 1-3 only a portion of a housing 44 surrounding at least one low voltage electron beam emitter is shown and to shield off the x-rays formed during usage of the emitter (not shown), the wall thickness is considerable, for example approximately 20 mm. The housing 44 is provided with a throughgoing opening 46 through the housing wall. The centre axis of the throughgoing opening 46 is located substantially perpendicular to the housing wall. The sensing elements 34 of the sensors 32 are adapted to be brought into communication with the inside of the housing 44, and therefore, the sensors 32 are adapted to extend through the throughgoing opening 46. Thus, the opening 46 is made large enough for the sensors 32 to extend through it. In the described embodiment the throughgoing opening 46 has a circular form, particularly an oval form through which both sensors 32 can extend. Because of the large wall thickness of the housing 44, the area around the throughgoing opening 46 is provided with a recess 48 for accomodating part of the sensor holder 10. The bottom surface 50 of the recess 48 is a surface 50, denoted second sealing surface 50, against which the housing interface portion 14 of the sensor holder 10 is to be tigthly sealed to when the sensor holder 10 is pressed towards the housing 44. The recess 48 can have any form suitable for accomodating the sensor holder 10, and in FIG. 1 it is shown a recess 48, which is oval.

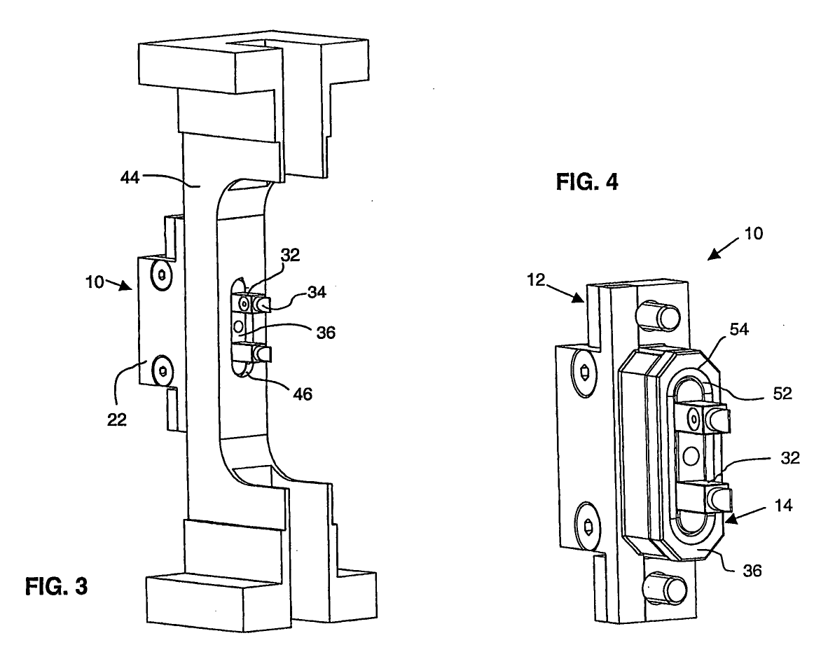

From the description above it can be understood that the relation between the length of the sensor 32, its location in the groove 30 of the clamping device 12, the depth of the recess 48 in the housing 44 and the housing 44 wall thickness should be such that at least the sensing element 34 of the sensor 32 projects into the space inside the housing 44, see FIG. 3. Alternatively, the sensing element of the sensor projects at least enough to form part of the housing wall so that the environment inside the housing 44 can be measured by the sensing element 34.

Between the first and second sealing surfaces 36, 50 a second sealing means 52 can be provided to further increase the sealing. Preferably, the sealing means should be compressible. In FIG. 4 it is shown that the sealing means 52 is a conventional O-ring 52, which is received in a groove 54 made in the first sealing surface 36 of the housing interface portion 14. The groove 54 is made around the sensor throughgoing openings 38, at a suitable distance from the edges of the throughgoing openings 38.

To tighten the sensor holder 10 to the housing 44, the clamping device 12 comprises third fastening means 56. The fastening means 56 can for example constitute a screw joint that comprises two flanges provided with screw throughgoing openings for screws. The flanges are arranged on upper and lower portions (in relation to FIG. 1) of the clamping device 12 and such that their throughgoing openings are substantially perpendicular to the housing 44. The housing 44 is provided with corresponding screw throughgoing openings above and below the recess 46 for receiving the screws.

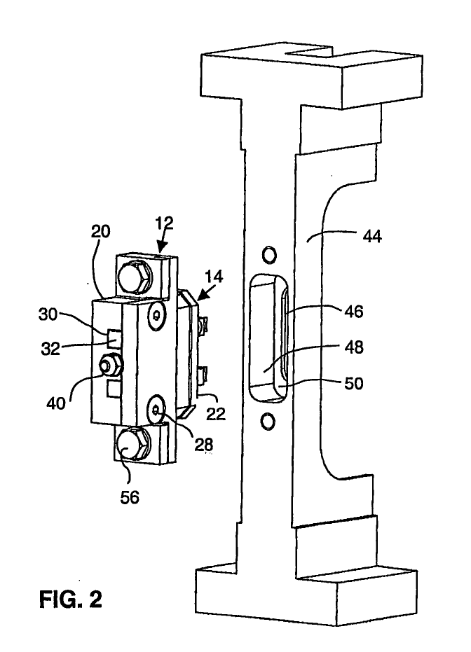

During assembly of the sensor holder 10 the sensors 32 are slid into the grooves 30 in the first portion 20 of the clamping device 12. Then the second portion 22 of the clamping device 12 is placed with its clamping surface 26 facing the clamping surface 24 of the first portion 20, and the two portions 20, 22 are tightened to each other by the first fastening means 28, thereby squeezing the sensors 32 between themselves. Afterwards, the first O-rings 42 are placed in the frusto conical portions of the openings 38 in the housing interface portion 14, after which the housing interface portion 14 is located so that its throughgoing openings 38 are slid over the portions of the sensors 32 that extend out from the clamping device 12. The two components, i.e. the clamping device 12 and the housing interface portion 14 are then tightened to each other by the second fastening means 40. The envelope surfaces of the throughgoing openings 38 will then be tightly sealed to the envelope surfaces of the sensor. The next step is to put the second O-ring 52 into its groove 52 in the first sealing surface 36 of the housing interface portion 14. The sensor holder 10 is now completed and can be fastened to the housing 44, see FIG. 2. The portions of the sensors 32 extending out from the sensor holder 10 are slid through the throughgoing opening 46 in the housing 44, see FIG. 3, and part of the sensor holder 10 is accomodated in the recess 48 around the throughgoing opening 46. The third fastening means 56 can then be tightened, whereby the first sealing surface 36 is tightly sealed against the second sealing surface 50 in the housing 44.

Although the present invention has been described with respect to a presently preferred embodiment, it is to be understood that various modifications and changes may be made without departing from the object and scope of the invention as defined in the appending claims.

A sensor holder 10 of this kind can for example be used in a device for electron beam irradiation of a web. In such a device an electron beam emitter is enclosed in a tunnel housing through which the web passes, and it is desired to sense the amount of electrons emitted from said emitter. Due to the forming of X-ray radiation during electron irradiation, the wall thickness normally large. Thus, the receiving throughgoing opening 46 for the sensor 32 and the recess 46 is preferably made with a circular form. Although only this example of a field of application is given it should be understood that the invention may be used in many other fields.

All the fastening means 28, 40, 56 have been described as screw joints. This is of course not the only type of fastening means that can be applicable. For example the fastening means can be an eccentric lock.

If the thickness of the housing 44 wall is relatively small it is not necessary to provide a recess 48 for the sensor holder 10 in connection with and around the throughgoing opening 46 in the housing 44, instead the housing interface portion 14 of the sensor holder 10 is pressed against the housing surface, and is sealed directly to the area around the throughgoing opening 46, the area being the second sealing surface 50. Moreover, the throughgoing opening 46 in the housing 44 can have any other form suitable for the sensors 32. For example, if there is only one sensor 32 the throughgoing opening 46 does not need to have an oval form, but can for example be circular instead.

In the example the number of sensors 32 are two, but it should be understood that the number can be any number suitable for the field of application in which the sensor holder 10 is used. For example the number can be one as well as three or more.

Further, the second fastening means 40 between the clamping device 12 and the housing interface portion 14 can be excluded. Instead the clamping device 12 and the housing interface portion 14 can be pressed together by the third fastening means 56, arranged between the sensor holder 10 and the housing 44, which at the same time will tighten the clamping device 12 to the housing interface portion 14.

Moreover, in the described embodiment the throughgoing opening of the second component is partly frusto conical. Alternatively, the throughgoing opening can be conical, whereby the conical form is similarly being widened towards the surface opposite the first surface.

In the embodiment the first and second sealing means 42, 52 used are conventional O-rings. However, it should be understood that other types of compressible sealing means can be used.

To prevent motion between the first and second portion 20, 22 of the clamping device 12, the first portion 20 is provided with a shoulder 29. Alternatively, the shoulder can of course be located on the second portion. Another alternative is to arrange the screw hole of the second fastening means close to the clamping surface of one of the portions such that the nut of the fastening means will extend, in its radial direction, past the joint between the first and second portions, and thereby act as a shoulder.

1. Sensor holder for arranging at least one sensor through a wall of a housing and into communication with an inside of a the housing, said sensor holder comprising a first and a second component,
the first component being adapted to hold said sensor,
the second component being provided with a first sealing surface and at least one throughgoing opening,
a portion of the sensor being adapted to extend from the first component, through the opening in the second component and into communication with the inside of the housing,
an envelope surface of the throughgoing opening in the second component being adapted to be tightly sealed to the sensor when pressing together the first and second component of the sensor holder, and
the first sealing surface of the second component being adapted to be tightly sealed to a second sealing surface provided in the housing when pressing together the sensor holder and the housing.

2. Sensor holder according to claim 1, whereby the throughgoing opening of the second component is at least frusto conical, the at least frusto conical form being widened towards a surface opposite the first sealing surface, and whereby first sealing means for sealing is provided in the at least frusto conical form of the throughgoing opening.

3. Sensor holder according to claim 1, whereby second sealing means for sealing is provided between the first sealing surface and the second sealing surface.

4. Sensor holder according to claim 2, whereby each of the first and second sealing means is a compressible sealing ring such as an O-ring.

5. Sensor holder according to claim 1, whereby the throughgoing opening in the second component of the sensor holder and the sensor have rectangular forms.

6. Sensor holder according to claim 1, whereby the throughgoing opening in the housing has an oval or circular form.

7. Sensor holder according to claim 3, whereby the first sealing surface being provided with a groove for receiving the second sealing means, the groove having an oval or circular form.

8. Sensor holder according to claim 1, whereby a first portion is provided with a groove adapted to receive at least a portion of the sensor.

9. Sensor holder according to claim 8, whereby the groove is rectangular and has a depth less than the length between two opposite sides of the sensor whereof one of said sides is facing the a bottom of the groove.

10. Sensor holder according to claim 8, whereby the first component further comprising a second portion and comprising fastening means for clamping together the first and second portions

11. Sensor holder according to claim 1, further comprising fastening means for tightening the first and second components to each other.

12. Sensor holder according to claim 1, further comprising fastening means for tightening the sensor holder to the housing.

13. Sensor holder according to claim 12, whereby the fastening means is a screw joint.

14. Sensor holder according to claim 2, wherein the throughgoing opening of the second component is conical.

15. Sensor holder according to claim 4, wherein the compressible sealing ring is an O-ring.

16. Sensor holder according to claim 10, wherein the fastening means is a screw joint.

17. Sensor holder according to claim 11, wherein the fastening means is a screw joint.
